(19) United States
(12) Patent Application Publication
(10) Pub. No.: US 2004/0137248 A1
(43) Pub. Date: Jul. 15, 2004

(54) Sound-proof composite system for space limiting surfaces

(76) Inventor: Manfried Elsasser, Patsch (AT)

Correspondence Address: Robert Kestenbaum, 11011 Bermuda Dunes NE, Albuquerque, NM, 87111, US

(21) Appl. No.: 10/465,943

(22) PCT Filed: Oct. 23, 2001
(86) PCT No.: PCT/EP01/12231

(30) Foreign Application Priority Data
Dec. 29, 2000 (JP) 00128689.7
Jul. 24, 2001 (EP) 01117926.4

(51) Int. Cl. B32B 27/08

(52) U.S. Cl. 428/476.3; 428/522; 428/500

(57) ABSTRACT

The invention relates to a sound proof composite system for space limiting surfaces comprising at least one coating layer (V) and one insulating layer (D)) made of at least three additional layers. By using modified polyolefins having at least a required higher percentage of comonomers in order to obtain said properties, more precisely in the form of m-PE/m-PP (VLDPE/VLDPP) or a soft PVC sheet (I) as a core for the insulating layer (D) in combination with at least two external single or multi-layered sheets (A) containing a barrier substance (A1), it is possible to obtain densities of the insulation layer (D)) of less than 1600 kg/m³ while ensuring good sound-proof qualities.

It is known from civil engineering physics that in buildings, sufficient footfall sound insulation of partition components and at the same time a realistic mass of these components can only be attained with multi-shell components (double-shell components, as a rule) or with a combination of heavy single-shell partition ceilings and softly resilient wear surfaces. Double-shell partition ceilings generally are realized as floating floor screeds, and thus, as a rule, give rise to relatively thick designs which especially in the renovation of old buildings having predetermined joining heights can hardly be installed in practice. When calculating the footfall sound improvement factor (FSIreq) of multi-shell ceiling covers that is required for the minimum footfall sound insulation of the full structure, not all European countries allow softly resilient wear surfaces to be taken into account. Moreover, such surfaces sometimes are not acceptable or not suitable, particularly so in wet areas (bathrooms).

In recent times, to the contrary, floor and wall coverings which are relatively thin and rigid are increasingly installed, for instance coverings consisting of chipboards or presspan panels in boarding sizes which have extremely hard surfaces, such as laminated plastic. The properties of these floor and wall coverings, which act as single-shell structures, are subjectively unpleasant and critical particularly with respect to sound projection into the walked rooms themselves.

Floor boarding glued directly only a raw ceiling certainly offer the most favorable prerequisites with respect to sound projection into the room, but hardly contribute to footfall sound insulation in this way, hence at least in the DACH countries (Germany, Austria, Switzerland) it is a practical requirement that they be laid onto floating floor screeds.

Combinations, usually of several layers to be used beneath or in connection with coverings or floorings, according to the prior art are disclosed for instance in the documents DE 197 22 513, DE 298 09 797 U, CH 645 150, EP 1 001 111, EP 0 864 712, or DE 196 37 142.

From the European patent application No. 00 117 926.4, a composite sound insulation system is known which through a suitable, specific combination of bending loss factor tan δ_{f} and uniaxial ductility loss factor tan δ_{c} in the layers of a composite sound insulation system makes possible dynamic stiffnesses beyond the value of 50 MN/M³ and, thus, small layer thicknesses. However, a thickness of the sound-proofing layer of more than 1600 kg/m³ is required for this sound insulation system.

Materials suitable for such sound-proofing layers which have a lower density than 1600 kg/m³ are available, for instance in the form of modified polyolefins (elastic components with partly sticky surfaces) or of soft PVC (nonsticky elastic component).

Polyolefins which at this time are already utilized on a large technical scale are polyethylene (PE) and polypropylene (PP). Basically two possibilities exist to modify these polyolefins so as to achieve a softer character more like that of elastomers, either by copolymerization or by the use of metallocene catalysts providing a much more precise control of polymerization, and making possible in this way the production of polyolefin sheet materials (m-PE, m-PP) having a low density (for instance, less than 900 kg/M³ in the instance of m-VLDPE, PP).

A modification of polyolefins by copolymerization is feasible with the aid of

vinyl acetate, methyl or ethyl or butyl or isobutyl acrylate, or with

block copolymers on the basis of ethylene or propylene or

comonomers on the basis of ethylene/octene.

However, modified polyolefins and particularly those having high fractions of the comonomers are beset by the problem of undesired sticking, and in the case of PVC, plasticizers must be added in order to attain the required flexibility, but plasticizers basically have the problem of migration from the base material into adjacent layers. Thus, problems associated with their contact with adjacent surfaces or materials exist for both materials.

The invention is based on the task of making it possible that sheets, either of very-low-density polyolefins (m-VLDPE, PP), that is, polyolefins having a very low density, preferably between 800 kg/M³ and 900 kg/M³, or of materials having a higher percentage of comonomers, preferably of 12 mole % to 40 mole %, or of materials with added plasticizers, become useful as components of a sound-proofing layer, thus augmenting the range of materials useful in the density range below 1600 kg/m³.

These tasks are tackled according to the invention, by the characterizing features of claim 1. Advantageous and alternative embodiments and further developments emerge from the features of the dependent claims.

The invention is based on the idea to form a sound-proofing layer, either from modified polyolefins (for instance very-low-density polyethylene [m-VLDPE]) or from materials having a higher percentage of comonomers such as is required as a minimum to achieve the desired properties (preferably 12 mole % to 40 mole %), or from a material that contains plasticizers, in which a special structure of the sound-proofing layer defines the contact to adjacent materials. In this structure, the core component, which for instance consists of soft and sticky, modified polyolefins or of nonsticky, elastic soft-PVC materials, is protected by cover or sealing layers applied on both sides (for instance against abrasion or plasticizer migration). Depending on the adjacent materials, it may happen that one of the two cover or sealing layers (for instance consisting of polypropylene PP, polyethylene PE, polyethylene terephthalate PET, or polyamide PA) or a barrier material can be omitted insofar as their function is fulfilled, for instance by the surface of the floor boards or by the room boundary surface.

Depending on the specific application, this sound-proofing layer can for instance be a floating composite of at least three layers:

protecting layer

core layer consisting of elastic polyolefin,

protecting layer or

protecting layer/barrier material

material containing plasticizers

protecting layer/barrier material

preferably formed as a coextruded laminated sheet which can be supplemented and optimized by further layers consisting of special materials.

In this example the floating composite having an “interlocked” sheet can be produced by coex blowmolding. Here, a sticky inner layer specifically selected gives rise to bonding of the laminate layers after compression or flattening of the blow-molded tubing.

Thus, the sound-proofing layer can be formed of a multitude of layers, for instance up to 14 coextruded layers, which depending on the composition of its layers is adaptable to a diversity of applications. For instance, layers which are colored, UV-stabilized, antistatic, diffusion-resistant, or particularly well sealing can be included. For the purposes of attaining a high density and reliably preventing the migration of plasticizers, it has been found to be particularly advantageous when the protecting layers are PP, PE, PET, or PA and the barrier material is an ethylene-vinyl alcohol copolymerizate (EVOH) or polyvinylidene chloride (PVDC), since in this case the permeability even for gases and thus the risk of diffusion is reduced by about 90%.

General examples of sheets consisting of extruded microlayers with barrier materials are known from the application WO 00/76765.

The composite sound insulation system according to the invention can be used, not merely for floor covers, for instance floor covers consisting of presspan panels, but basically as well for wall and ceiling covers as well as for all floor structures without a floating floor screed, and particularly for those having load-distributing wear surfaces.

The invention is explained in greater detail in the instance of the appended drawing. The embodiments represented concern the use of a layer of a material containing plasticizers, merely as an example, but can also serve as a description when other materials are used, such as modified polyolefins. Shown are in

FIG. 1 the scheme of the individual components of a composite sound insulation system according to the invention;

FIG. 2 a composite sound insulation system according to the invention that has been applied to a room boundary surface;

FIG. 3 the scheme of layer structure of the sound-proofing layer according to the invention;

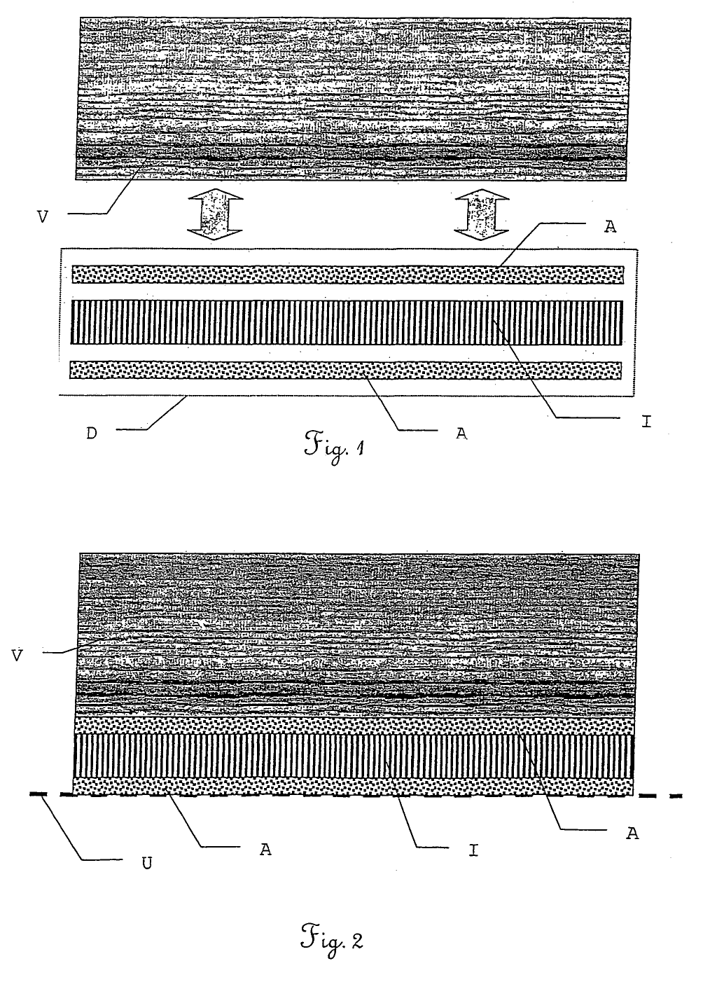

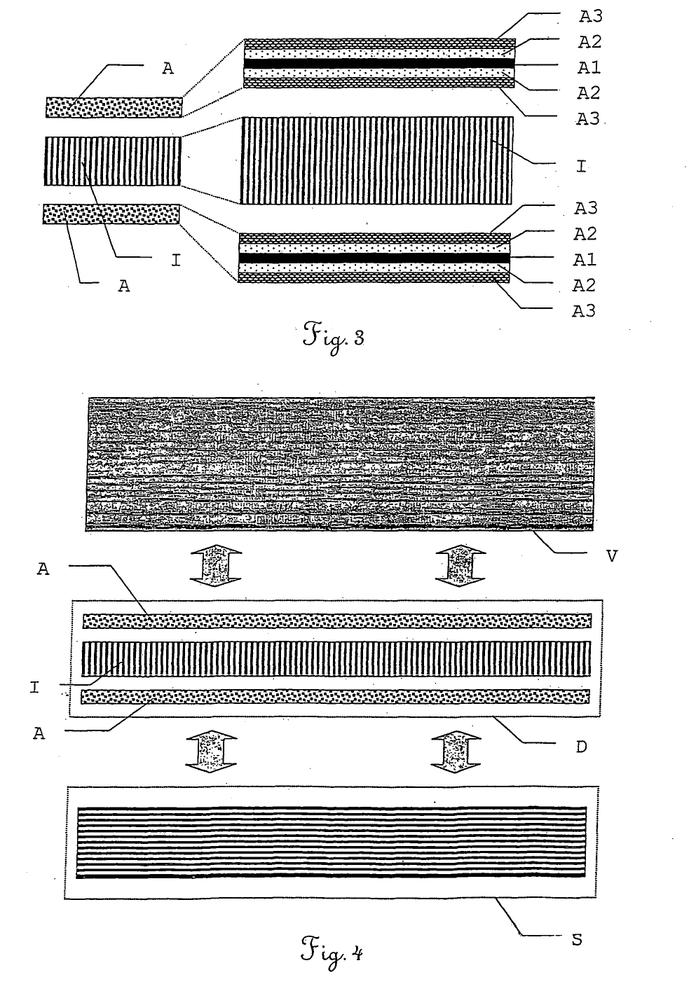

FIG. 4 the individual components of a composite sound insulation system according to the invention having an additional footfall sound-insulating layer; and

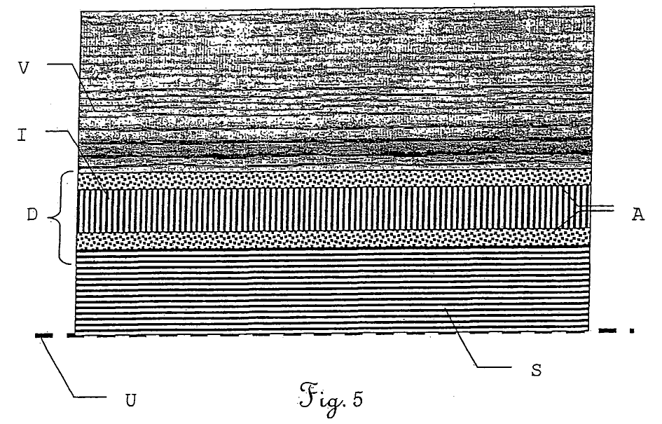

FIG. 5 a composite sound insulation system according to the invention having an additional footfall sound-insulating layer that has been applied to a room boundary surface.

FIG. 1 schematically shows the individual components of a composite sound insulation system according to the invention. A sound-proofing layer D is applied, for instance by full-area glueing, to one side of a covering layer V, constituted here merely as an example of a solid wooden boarding. The sound-proofing layer consists of an inner sheet I inserted between two outer sheets A. Basically, further layers of sheet can be added to this layer structure in order to attain further, specific properties of the sound-proofing layer D.

FIG. 2 shows the composite sound insulation system that has been applied, as an example, to a room boundary surface U. The room boundary surface can be a floor surface as well as a ceiling or wall surface. An inner sheet I enclosed between two outer sheets A is present between this room boundary surface and the covering layer V.

The detailed layer structure of the sound-proofing layer D is shown in FIG. 3. In this example, the two outer sheets A each consist of five bonded layers, for instance of a coex blow-molded sheet. An innermost layer of barrier material A1 is enclosed by two bond-improving and/or load-distributing layers A2. The outer layers consist of two outer layers A3, for instance consisting of a weldable material. Depending on the materials used, the functions of two layers may occasionally be combined into one layer. For instance, it may be possible to do without the bond-improving and/or load-distributing layers A2 if by a direct bonding of the outer layer A3 to the barrier material A1 the desired properties can be realized. It was found that PP, PE, PET or PA and in particular the ethylene-vinyl alcohol copolymerizate (EVOH) or polyvinylidene chloride are suitable protecting layers or barrier materials suppressing a migration of monomeric or polymeric plasticizers. Polyamide (PA) can for instance be used as a bond-improving and/or load-distributing layer, and a suitable glue can be used as bonding agent.

Basically, the two outer layers A can be different in their inner structure, so that on the whole an asymmetric structure of the sound-proofing layer is obtained. This may for instance constitute an advantage when the particular chemical or physical properties of the surfaces of room boundary surface, covering layer, or other layers that are to be added must be taken into account.

FIG. 4 shows the use of such a further layer being added. To the side of the sound-proofing layer D (itself consisting of an inner sheet I and two outer sheets A) that is turned away from the covering layer V, an additional footfall sound-insulating layer S is applied. The bonding can be full-area glueing, but the combination of covering layer and sound-proofing layer can also merely be laid out on top of the footfall sound-insulating layer. By mutually harmonized optimization of the materials parameters of the sound insulation system, now consisting of two layers, the overall behavior of this system can be adapted to the particular conditions on hand. For instance, by a suitable combination of bending loss factor of the sound-proofing layer on one hand and of the uniaxial ductility loss factor and dynamic stiffness of the footfall sound-insulating layer S on the other hand, one can attain a high-grade footfall sound insulation in addition to a substantial improvement of the covering layer V with respect to its sound projection into the room while small layer thicknesses of the overall system can be admitted even with surprisingly high dynamic stiffnesses.

This can for instance be achieved by selecting for the inner sheet I a bending loss factor tan δ_{f}≧0.08 and for the footfall sound-insulating layer S, either a uniaxial ductility loss factor tan δ_{c}<0.17 together with a dynamic stiffness s′<30 MN/M³, or a uniaxial ductility loss factor tan δ_{c}≧0.17 together with a dynamic stiffness s′≧30 MN/M³.

FIG. 5 schematically shows the composite sound insulation system that has been applied to a room boundary surface U. An additional footfall sound-insulating layer S has been inserted between the covering layer with sound-proofing layer D (consisting of an inner layer I and outer layers A) and the room boundary surface U.

The thickness ratios seen in FIGS. 1 to 5 must not be seen as limiting. For instance, the covering layer V may be thinner (for instance, a 5 mm hardboard or a laminate layer, so long as it has a load-distributing function) or thicker than the sound-proofing layer D. If the covering layer V has been chosen to be relatively thin, then the sound-proofing layer D will constitute a (substantially thicker) supporting layer that can be optimized by special selection of additives with respect to the properties to be attained.

1. Composite sound insulation system for a room boundary surface (U), comprising
(i) a floor, wall, or ceiling covering (V) and
(ii) a sound-proofing layer (D) adjacent to the given covering, and if appropriate glued to it,
characterized in that
the sound-proofing layer (D) consists of
at least two outer sheets (A) serving as cover layers and
at least one intermediate inner sheet (I) serving as the elastic core, and having a density of <1600 kg/m³, preferably of <1400 kg/m³, particularly of modified polyolefins or soft PVC.

2. Composite sound insulation system according to claim 11
characterized in that
at least one of the outer sheets (A) contains at least one layer of barrier material or consists of such material.

3. Composite sound insulation system according to claim 2,
characterized in that
the barrier material (A1), preferably ethylene-vinyl alcohol copolymerizate (EVOH), polyvinylidene chloride (PVDC), or polyethylene terephthalate (PET), is embedded between two layers (A2) of a bond-improving material, such as a bonding agent, and/or a load-distributing material such as polyamide (PA).

4. Composite sound insulation system according to one of the preceding claims,
characterized in that
at least one of the outer sheets (A) has an outer layer (A3) of a weldable material, preferably polypropylene (PP) or polyethylene (PE) and/or consists of such a material.

5. Composite sound insulation system according to claim 3,
characterized in that
the inner sheet (I) consists of several layers in floating arrangement, preferably at least one of them consisting of a block copolymer.

6. Composite sound insulation system according to one of the preceding claims,
characterized in that
the inner sheet (I) has a bending loss factor tan δ_{f}≧0.08.

7. Composite sound insulation system according to one of the preceding claims,
characterized in that
the inner sheet (I) has a thickness of <3.0 mm, preferably a thickness between 0.3 mm and 3.0 mm.

8. Composite sound insulation system according to one of the preceding claims,
characterized by
a footfall sound-insulating layer (S) adjacent to the sound-proofing layer (D).

9. Composite sound insulation system according to claim 8,
characterized in that
the footfall sound-insulating layer (S) has
either a uniaxial ductility loss factor tan δ_{c}<0.17 and a dynamic stiffness s'<30 MN/m³
or a uniaxial ductility loss factor tan 8, >0.17 and a dynamic stiffness of s'>30 MN/m³.

10. Composite sound insulation system according to claim 8 or 9,
characterized in that
the footfall sound-insulating layer (S) has a thickness of <4.0 mm, preferably a thickness between 2.0 mm and 4.0 mm.
